(19) United States
(12) Patent Application Publication
(10) Pub. No.: US 2017/0093149 A1
(43) Pub. Date: Mar. 30, 2017

(54) MOTOR DRIVING CIRCUIT AND METHOD FOR DETECTING OUTPUT PHASE LOSS

(71) Applicants: LITE-ON TECHNOLOGY CORPORATION, TAIPEI CITY (TW); LITE-ON ELECTRONICS (GUANGZHOU) LIMITED, GUANGZHOU (CN)

(72) Inventors: PANG-YOU LIU, TAIPEI CITY (TW); CHIH-JUNG HSU, NEW TAIPEI CITY (TW); CHI-PHON LIN, NEW TAIPEI CITY (TW)

(21) Appl. No.: 14/953,363

(22) Filed: Nov. 29, 2015

(30) Foreign Application Priority Data
Sep. 25, 2015 (CN) 201510627269.7

(51) Int. Cl. H02H 7/09

(52) U.S. Cl. CPC H02H 7/09

(57) ABSTRACT

A motor driving circuit and a method for detecting output phase loss are disclosed, which detect and integrate a three-phase direct current to generate a current integration, and to determine whether a motor configured in the motor driving circuit operates in a phase loss condition according to the current value of the current integration. When the current value of the current integration is a constant value, the motor driving circuit determines that the motor operates in a normal condition, and drives the motor continuously. When the current value of the current integration is a low current value (e.g., 0 A), the motor driving circuit determines that the motor operates in a phase loss condition, and stops driving the motor. Therefore, when the motor driving circuit and the method generate the higher current because of operating in the phase loss condition, it can avoid burning out the motor driving circuit.

### BACKGROUND

1. Technical Field

The present invention relates to a motor driving circuit and a method for detecting output phase loss, in particular, to a motor driving circuit and a method for detecting whether a motor operates in a phase loss condition.

2. Description of Related Art

A motor is a necessary power transformation device in modern industries. The motor is capable of transforming electricity into kinetic energy required for driving devices. The motor is often applied to drive one element of the electronic device, for example, blades of the fan device are usually rotated with the motor. Therefore, how to design an efficient motor has become a major objective in the industry.

The motor driving circuit drives the motor, to further drive the elements configured in the motor. However, the motor driving circuit may cause a phase loss operation (i.e., the motor operating in a phase loss condition may cause abnormal operation), to generating higher current because the circuit does not contact well. When the current becomes higher, it may burn out coils configured in the motor driving circuit. Therefore, it is necessary to detect whether the motor operates in the phase loss condition, to avoid damaging the motor driving circuit.

### SUMMARY

An exemplary embodiment of the present disclosure provides a motor driving circuit for detecting output phase loss. The motor driving circuit is used for driving a motor and determines whether the motor operates in a phase loss condition. The motor driving circuit includes a three-phase rectifier, a full-bridge circuit, a shunt resistor, an integrator, and a control circuit. The three-phase rectifier has a positive terminal and a negative terminal. The three-phase rectifier is configured for receiving a three-phase alternating current. The three-phase rectifier transforms the three-phase alternating current into a three-phase direct current and outputs the three-phase direct current from the positive terminal. The full-bridge circuit is coupled between the three-phase rectifier and the motor. The full-bridge circuit is configured for operating the phase commutation according to a plurality of control signals to transmit the three-phase direct current from the positive terminal to the motor and to transmit the three-phase direct current from the motor to the negative terminal for controlling the operation of the motor. The shunt resistor is connected in series between the positive terminal and the full-bridge circuit or is connected in series between the negative terminal and the full-bridge circuit. The integrator is electrically connected to the shunt resistor. The integrator is configured for detecting the three-phase direct current flowing through the shunt resistor, and integrates the three-phase direct current to generate a current integration. The control circuit is electrically connected to the integrator. The control circuit is configured for determining whether the current integration is a low current value. When the current integration is the low current value, the control circuit determines that the motor operates in the phase loss condition to stop driving the motor.

An exemplary embodiment of the present disclosure provides a method for detecting output phase loss. The method is adapted for a motor driving circuit. The motor driving circuit is configured for driving a motor and determines whether the motor operates in a phase loss condition. The method includes the following steps: receiving a three-phase alternating current, and transforming the three-phase alternating current into a three-phase direct current; operating the phase commutation according to a plurality of control signals to transmit the three-phase direct current from the positive terminal to the motor and to transmit the three-phase direct current from the motor to the negative terminal for controlling the operation of the motor; detecting the three-phase direct current flowing through the positive terminal or the negative terminal, and integrating the three-phase direct current to generate a current integration; and determining whether the current integration is a low current value. When the current integration is the low current value, determining that the motor operates in the phase loss condition to stop driving the motor.

To sum up, the present disclosure provides a motor driving circuit and a method for detecting output phase loss. When the motor driving circuit determines that the motor operates in the phase loss condition, the motor driving circuit stops driving the motor, avoiding the motor driving circuit generating the higher current that would burn out the motor driving circuit because of operating in the phase loss condition.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention.

FIG. 1 shows a diagram of a motor driving circuit for detecting output phase loss according to an embodiment of the present disclosure.

FIG. 2A shows a wave diagram of a current integration in a phase loss condition according to an embodiment of the present disclosure.

FIG. 2B shows a wave diagram of a current integration in no phase loss condition according to an embodiment of the present disclosure.

FIG. 3 shows a diagram of a motor driving circuit for detecting output phase loss according to another embodiment of the present disclosure.

FIG. 4 shows a flowchart of a motor driving circuit for detecting output phase loss according to an embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

This embodiment provides a motor driving circuit and a method for detecting output phase loss, which detect and integrate a three-phase direct current to generate a current integration, and to determine whether a motor operates in a phase loss condition according to the current value of the current integration. When the current value of the current integration is a constant value, the motor driving circuit determines that the motor operates in a normal condition, and then drives the motor continuously. Otherwise, when the current value of the current integration is a low current value (e.g., 0 Amp), the motor driving circuit determines that the motor operates in a phase loss condition, and then stops driving the motor. Therefore, when the motor driving circuit and the method for detecting output phase loss generate the higher current because of operating in the phase loss condition, it can avoid burning out the motor driving circuit. The motor driving circuit and the method for detecting output phase loss provided in the exemplary embodiment of the present disclosure will be described in the following paragraphs.

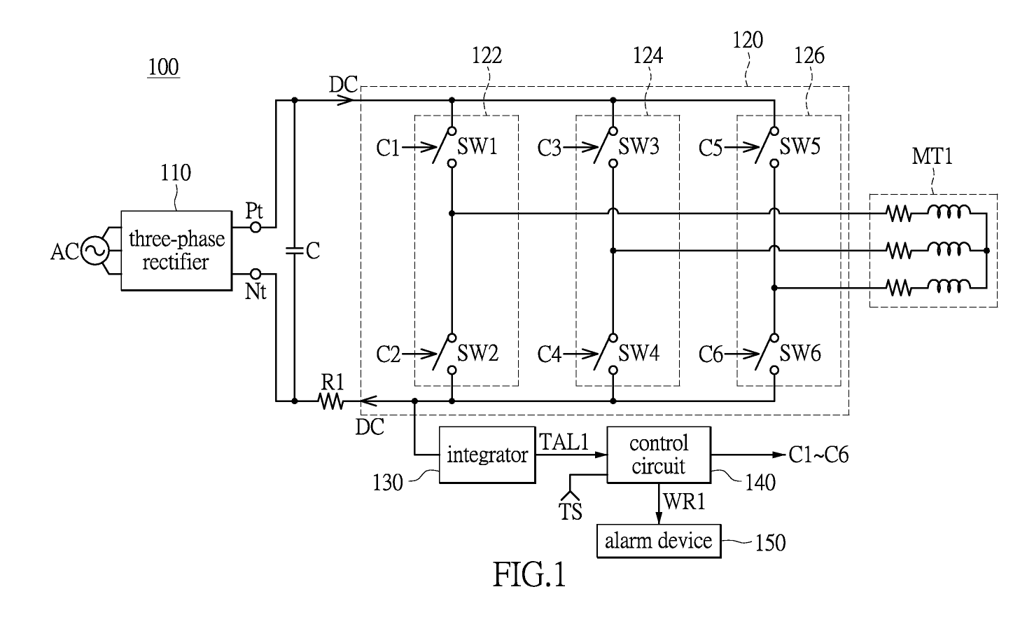

Firstly, please refer to FIG. 1, which shows a diagram of a motor driving circuit for detecting output phase loss according to an embodiment of the present disclosure. As shown in FIG. 1, a motor driving circuit 100 for detecting output phase loss is used to drive a motor MT1 and determines whether the motor MT1 operates in a phase loss condition. The motor driving circuit 100 includes a three-phase rectifier 110, a full-bridge circuit 120, a shunt resistor R1, an integrator 130, and a control circuit 140.

The three-phase rectifier 110 is electrically connected to an external alternating current power, to receive a three-phase alternating current AC. The three-phase rectifier 110 has a positive terminal Pt and a negative terminal Nt, to transform the three-phase alternating current AC into a three-phase direct current DC. Then the three-phase rectifier 110 outputs the three-phase direct current DC from the positive terminal Pt. The full-bridge circuit 120 is coupled between the three-phase rectifier 110 and the motor MT1, and receives the three-phase direct current DC. The full-bridge circuit 120 operates the phase commutation according to a plurality of control signals C1, C2, C3, C4, C5, and C6, to transmit the three-phase direct current DC from the positive terminal Pt to the motor MT1. Then the motor MT1 transmits the three-phase direct current DC to the negative terminal Nt, to control the operation of the motor MT1 accordingly.

As shown in FIG. 1, in the present disclosure, the control signals C1-C6 are generated by a control circuit 140. The motor MT1 is a three-phase motor. The full-bridge circuit 120 connected to the motor MT 1 is a three-phase full bridge circuit having three bridge-arms configured in parallel. The three bridge-arms are the first bridge-arm 122, the second bridge-arm 124, and the third bridge-arm 126 respectively. The first bridge-arm 122 has a first switch SW1 and a second switch SW2. An end of the first switch SW1 is coupled to the positive terminal Pt. The other end of the first switch SW1 is coupled to an end of the second switch SW2. The other end of the second switch SW2 is coupled to the negative terminal Nt. The second bridge-arm 124 has a third switch SW3 and a fourth switch SW4. An end of the third switch SW3 is coupled to the positive terminal Pt. The other end of the third switch SW3 is coupled to an end of the fourth switch SW4. The other end of the fourth switch SW4 is coupled to the negative terminal Nt. The third bridge-arm 126 has a fifth switch SW5 and a sixth switch SW6. An end of the fifth switch SW5 is coupled to the positive terminal Pt. The other end of the fifth switch SW5 is coupled to an end of the sixth switch SW6. The other end of the sixth switch SW6 is coupled to the negative terminal Nt. In the present disclosure, the first switch SW1, the third switch SW3, and the fifth switch SW5 are PMOS transistors, and the second switch SW2, the fourth switch SW4, and the sixth switch SW6 are NMOS transistors. The first switch SW1, the second switch SW2, the third switch SW3, the fourth switch SW4, the fifth switch SW5, and the sixth switch SW6 can be other kinds of switches, and the present disclosure is not limited thereto.

The control circuit 140 generates six control signals C1-C6 according to a phase switching signal TS, to respectively control the turn-on and turn-off of the first switch SW1, the second switch SW2, the third switch SW3, the fourth switch SW4, the fifth switch SW5, and the sixth switch SW6 of the full-bridge circuit 120, so that the three-phase direct current DC is transmitted from the positive terminal Pt to the motor MT1 and then is transmitted from the motor MT1 to the negative terminal Nt, to control the operation of the motor MT1. Persons of ordinary skill in this technology field should realize the implementation of the phase commutation between the motor

MT1 and the full-bridge circuit 120, and the operation of the motor MT1, so detailed description is omitted.

It is worth to note that the shunt resistor R1 is connected in series between the negative terminal Nt and the full-bridge circuit 120, so that the three-phase direct current DC flows through the shunt resistor R1. More specifically, an end of the shunt resistor R1 is electrically connected to the negative terminal Nt, and the other end of the shunt resistor R1 is electrically connected to the full-bridge circuit 120. The integrator 130 is electrically connected to the shunt resistor R1, to detect the three-phase direct current DC flowing through the shunt resistor R1. In the present disclosure, the integrator 130 is electrically connected between the shunt resistor R1 and the full-bridge circuit 120. The integrator 130 can be electrically connected between the shunt resistor R1 and the negative terminal Nt. The present disclosure is not limited thereto. Therefore, the integrator 130 integrates the three-phase direct current DC, to generate a current integration TAL1 accordingly.

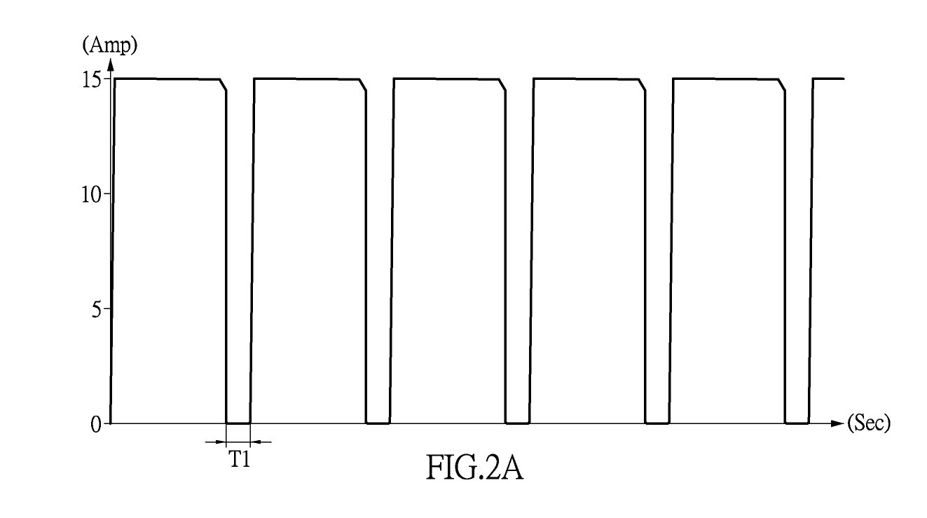

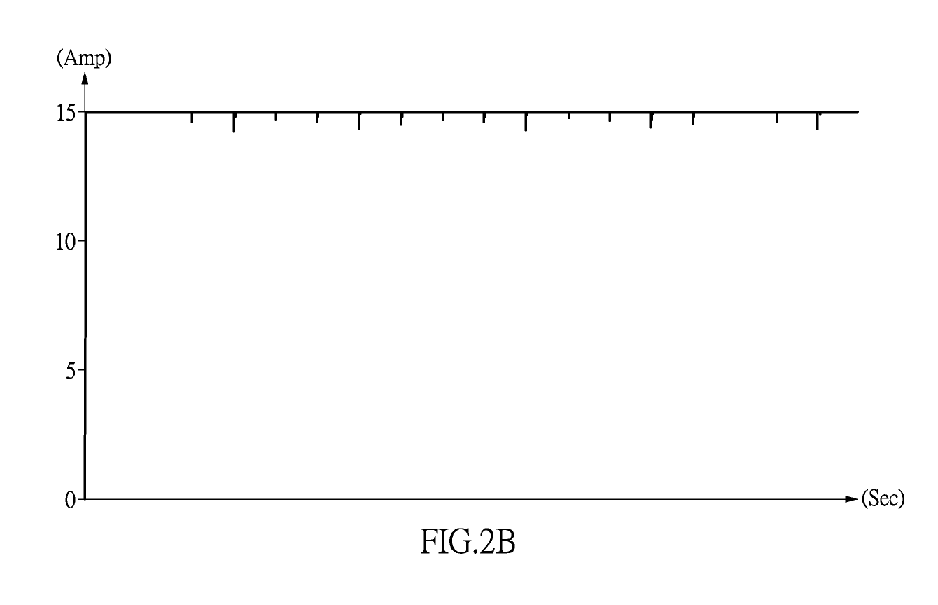

The control circuit 140 is electrically connected between the integrator 130 and the full-bridge circuit 120. The control circuit 140 determines whether the current integration TAL1 is a low current value. This means that the control circuit 140 detects the current value of the current integration TAL1, to determine whether the motor MT1 operates in the phase loss condition. Therefore, when the current integration TAL1 is the low current value, the control circuit 140 determines that the motor MT1 operates in the phase loss condition and then stops driving the motor MT 1. When the current value of the current integration TAL1 is a constant value (e.g., the current value of the current integration TAL1 is 15 Amp as shown in FIG. 2B), the control circuit 140 determines that the motor MT1 operates in a normal condition and then drives the motor MT1 continuously. In the present disclosure, the control circuit 140 is a DSP, MCU, or other electronic element which can determine whether the motor MT1 operates in the phase loss condition and can control the full-bridge circuit 120 operating the phase commutation. The present disclosure is not limited thereto.

Please refer to FIG. 2A in conjunction with FIG. 1. FIG. 2A shows a wave diagram of a current integration in a phase loss condition according to an embodiment of the present disclosure. In the present disclosure, when the integrator 130 generates the current integration TAL1 to be 0, the control circuit 140 determines that the current integration TAL1 is the low current value. It indicates the motor MT1 operates in the phase loss condition. Then the control circuit 140 generates the low-level control signals C1-C6, to turn off the first switch SW1, the second switch SW2, the third switch SW3, the fourth switch SW4, the fifth switch SW5, and the sixth switch SW6, so that the motor MT1 is stopped driving.

In another embodiment, when the integrator 130 generates the current integration TAL1 to be 0 for a predefined time T1, the control circuit 140 determines that the current integration TAL1 is the low current value. This avoids that the integrator 130 temporarily generates the current integration TAL1 to be 0 (i.e., time of generating the current integration TAL1 to be 0 is less than the predefined time T1) because the three-phase direct current D1 has noise. Therefore, the control circuit 140 does not misjudge the motor operating in the phase loss condition.

Similarly, in another embodiment, when the integrator 130 periodically generates the current integration TAL1 to be 0, the control circuit 140 determines the current integration TAL1 is the low current value. Therefore, the control circuit 140 can determine the result of the current integration TAL1 instead of misjudging the motor MT1 operating in the phase loss condition. The control circuit 140 can also determine whether the current integration TAL1 is the low current value according to other waveform features of the current integration TAL1. The present disclosure is not limited thereto.

Next, please refer to FIG. 2B, which shows a wave diagram of a current integration in no phase loss condition according to an embodiment of the present disclosure. As shown in FIG. 2B, the current integration TAL1 is 15 Amp, and the integrator 130 does not generate the current integration TAL1 to be 0. Then the control circuit 140 determines the motor MT1 operates in the normal condition, and drives the motor MT1 continuously.

Please refer to FIG. 1. The motor driving circuit 100 further includes a voltage-regulating capacitor C electrically connected between the positive terminal Pt and the negative terminal Nt, to provide the stable direct voltage to the full-bridge circuit 120. In addition, the motor driving circuit 100 further includes an alarm device 150. The alarm device 150 is coupled to the control circuit 140. When the control circuit 140 determines that the motor MT1 operates in the phase loss condition, the alarm device 150 executes an alarm procedure. More specifically, when the control circuit 140 determines that the motor MT1 operates in the phase loss condition, the control circuit 140 generates an alarm signal WR1 to the alarm device 150. The alarm device 150 executes the alarm procedure according to the alarm signal WR1. For example, the alarm device 150 has a LED element. Therefore, when the alarm device 150 receives the high-level alarm signal WR1, the alarm device 150 lights the LED element, to notify the user that the motor operates in the phase loss condition.

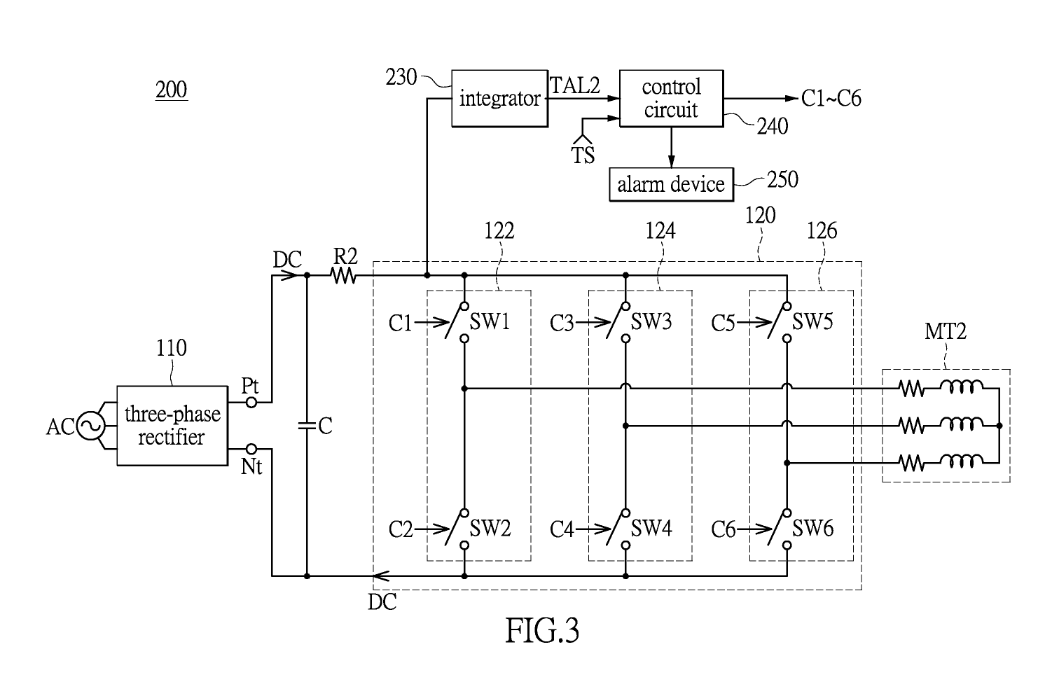

It is worth to note that, in another embodiment, the shunt resistor can be configured in the path flowing through the three-phase direct current DC. As shown in FIG. 3, the shunt resistor R2 of the motor driving circuit 200 is connected in series between the positive terminal Pt and the full-bridge circuit 120, so that the three-phase direct current DC flows through the shunt resistor R2. More specifically, an end of the shunt resistor R2 is electrically connected to the positive terminal Pt, and the other end of the shunt resistor R2 is electrically connected to the full-bridge circuit 120. The integrator 230 is electrically connected to the shunt resistor R2, to detect the three-phase direct current DC flowing through the shunt resistor R2. In the present disclosure, the integrator 230 is electrically connected between the shunt resistor R2 and the full-bridge circuit 120. The integrator 230 can be electrically connected between the shunt resistor R2 and the positive terminal Pt. The present disclosure is not limited thereto. Therefore, the integrator 230 integrates the three-phase direct current DC, to generate a current integration TAL2 accordingly.

The control circuit 240 is electrically connected between the integrator 230 and the full-bridge circuit 120. The control circuit 240 determines whether the current integration TAL2 is a low current value. This means that the control circuit 240 detects the current value of the current integration TAL2, to determine whether the motor MT2 operates in the phase loss condition. Therefore, when the current integration TAL2 is the low current value, the control circuit 240 determines that the motor MT2 operates in the phase loss condition and then stops driving the motor MT2. When the current value of the current integration TAL2 is a constant value (e.g., the current value of the current integration TAL2 is 15 Amp as shown in FIG. 2B), the control circuit 240 determines that the motor MT2 operates in a normal condition and then drives the motor MT2 continuously.

With respect to operations of the control circuit 240 determining whether the current integration TAL2 is the low current value and of the alarm device 250, they are the same as that of the control circuit 140 and the alarm device 150, so detailed description is omitted.

Therefore, the integrator detects and integrates the three-phase direct current by the shunt resistor, to generate the current integration. When the current integration is the low current value, the control circuit determines that the motor operates in the phase loss condition, and then stops driving the motor. It can avoid burning out the motor driving circuit because of generating the higher current in the phase loss condition.

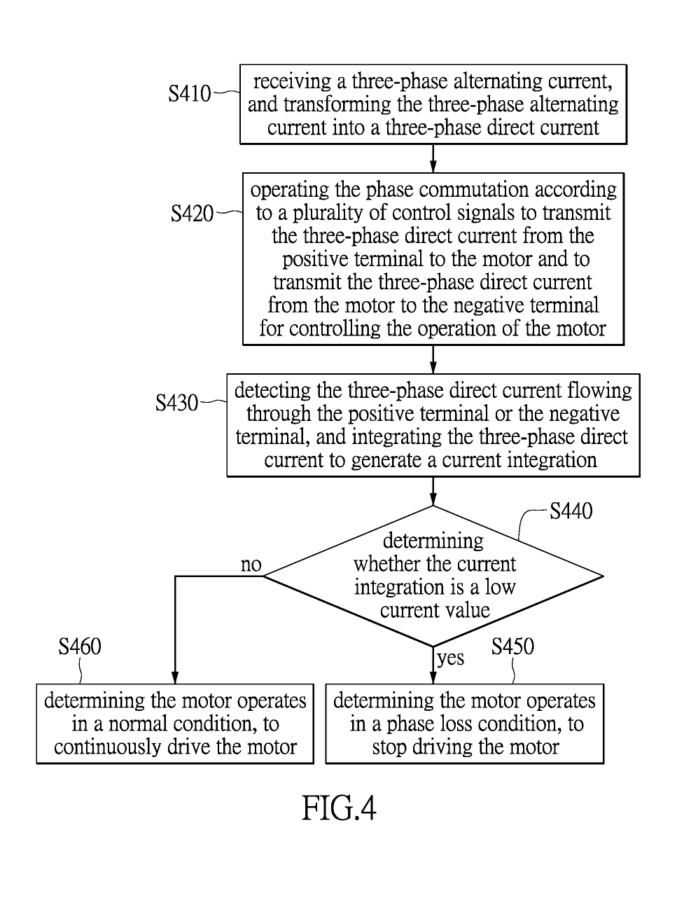

From the aforementioned exemplary embodiments, the present invention may generalize a method for detecting output phase loss, which is adapted for the aforementioned motor driving circuits 100 and 200. For the convenience in the description, the following description is based on the example that the motor driving circuit 100 drives the motor MT1, and then determines whether the motor MT1 operates in a phase loss condition. Please refer to FIG. 4 in conjunction with FIGS. 1 and 3. Firstly, the motor driving circuit 100 receives a three-phase alternating current AC, and then transforms the three-phase alternating current AC into a three-phase direct current DC (step S410).

Next, the motor driving circuit 100 operates the phase commutation according to a plurality of control signals C1-C6, to transmit the three-phase direct current DC from the positive terminal Pt to the motor MT1, and to transmit the three-phase direct current DC from the motor MT1 to the negative terminal Nt for controlling the operation of the motor MT1 (step S420). Step S420 is illustrated in the motor driving circuit 100 of the aforementioned exemplary embodiments. Persons of ordinary skill in this technology field should understand the motor driving circuit 100 operating the phase commutation and the operation of the motor MT1, so detailed description is omitted.

Furthermore, the motor driving circuit 100 detects the three-phase direct current DC flowing through the positive terminal Pt or the negative terminal Nt, and then integrates the three-phase direct current DC to generate a current integration (step S430). Step S430 is illustrated in the motor driving circuit 100 of the aforementioned exemplary embodiments, so detailed description is omitted.

After generating the current integration, the motor driving circuit 100 further determines whether the current integration is a low current value, to determine whether the motor MT1 operates in the phase loss condition (step S440). When the motor driving circuit 100 determines that the current integration is the low current value, it determines that the motor MT1 operates in the phase loss condition. Next, the motor driving circuit 100 stops driving the motor MT1, to avoid the abnormal operation of the motor MT1 (step S450). Otherwise, when the motor driving circuit 100 determines that the current integration is not the low current value, it determines that the motor MT1 operates in the normal condition. The motor driving circuit 100 drives the motor MT1 continuously, to keep the normal operation of the motor MT1 (step S460). Steps S440-S460 are illustrated in the motor driving circuit 100 of the aforementioned exemplary embodiments, so detailed description is omitted.

In summary, the present disclosure provides a motor driving circuit and a method for detecting output phase loss. When the motor driving circuit determines that the motor operates in the phase loss condition, the motor driving circuit stops driving the motor. This avoids the motor driving circuit generating the higher current which would burn out the motor driving circuit because of operating in the phase loss condition.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A motor driving circuit for detecting output phase loss, used for driving a motor, and determining whether the motor operates in a phase loss condition, the motor driving circuit comprising:
a three-phase rectifier, having a positive terminal and a negative terminal, configured for receiving a three-phase alternating current, transforming the three-phase alternating current into a three-phase direct current, and outputting the three-phase direct current from the positive terminal;
a full-bridge circuit, coupled between the three-phase rectifier and the motor, configured for operating the phase commutation according to a plurality of control signals to transmit the three-phase direct current from the positive terminal to the motor and to transmit the three-phase direct current from the motor to the negative terminal for controlling the operation of the motor;
a shunt resistor, connected in series between the positive terminal and the full-bridge circuit or connected in series between the negative terminal and the full-bridge circuit;
an integrator, electrically connected to the shunt resistor, configured for detecting the three-phase direct current flowing through the shunt resistor, and integrating the three-phase direct current to generate a current integration; and
a control circuit, electrically connected to the integrator, configured for determining whether the current integration is a low current value, wherein when the current integration is the low current value, the control circuit determines that the motor operates in the phase loss condition to stop driving the motor.

2. The motor driving circuit according to claim 1, wherein when the integrator generates the current integration to be 0, the control circuit determines that the current integration is the low current value.

3. The motor driving circuit according to claim 1, wherein when the integrator generates the current integration to be 0 for a predefined time, the control circuit determines the current integration is the low current value.

4. The motor driving circuit according to claim 1, wherein when the integrator periodically generates the current integration to be 0, the control circuit determines the current integration is the low current value.

5. The motor driving circuit according to claim 1, wherein the full-bridge circuit comprises:
a first bridge-arm, having a first switch and a second switch, an end of the first switch coupled to the positive terminal, another end of the first switch coupled to an end of the second switch, and another end of the second switch coupled to the negative terminal;
a second bridge-arm, having a third switch and a fourth switch, an end of the third switch coupled to the positive terminal, another end of the third switch coupled to an end of the fourth switch, and another end of the fourth switch coupled to the negative terminal; and
a third bridge-arm, having a fifth switch and a sixth switch, an end of the fifth switch coupled to the positive terminal, another end of the fifth switch coupled to an end of the sixth switch, and another end of the sixth switch coupled to the negative terminal;
wherein when the control circuit determines that the motor operates in a phase loss condition, the control circuit generates the low-level control signals, to turn-off the first switch, the second switch, the third switch, the fourth switch, the fifth switch, and the sixth switch.

6. The motor driving circuit according to claim 1, further comprising:
an alarm device, coupled to the control circuit, wherein when the control circuit determines that the motor operates in the phase loss condition, the alarm device executes an alarm procedure.

7. A method for detecting output phase loss, adapted for a motor driving circuit, the motor driving circuit configured for driving a motor and determining whether the motor operates in a phase loss condition, the method comprising:
receiving a three-phase alternating current, and transforming the three-phase alternating current into a three-phase direct current;
operating the phase commutation according to a plurality of control signals to transmit the three-phase direct current from the positive terminal to the motor and to transmit the three-phase direct current from the motor to the negative terminal for controlling the operation of the motor;
detecting the three-phase direct current flowing through the positive terminal or the negative terminal, and integrating the three-phase direct current to generate a current integration; and
determining whether the current integration is a low current value, wherein when the current integration is the low current value, determining that the motor operates in the phase loss condition to stop driving the motor.

8. The method for detecting output phase loss according to claim 7, wherein the step of determining whether the current integration is the low current value, further comprises:
when generating the current integration to be 0, determining that the current integration is the low current value.

9. The method for detecting output phase loss according to claim 7, wherein the step of determining whether the current integration is the low current value, further comprises:
when generating the current integration to be 0 for a predefined time, determining that the current integration is the low current value.

10. The method for detecting output phase loss according to claim 7, wherein the step of determining whether the current integration is the low current value, further comprises:
when periodically generating the current integration to be 0, determining that the current integration is the low current value.
